(19) United States
(12) Patent Application Publication
(10) Pub. No.: US 2020/0136660 A1
(43) Pub. Date: Apr. 30, 2020

(54) LOOPBACK INTERFERENCE CANCELLATION

(71) Applicant: Avago Technologies International Sales Pte. Ltd., Singapore (SG)

(72) Inventors: Arya Behzad, San Jose, CA (US); Hossein Roufarshbaf, San Jose, CA (US); Avi Sulimarski, Tel Aviv (IL)

(21) Appl. No.: 16/577,446

(22) Filed: Sep. 20, 2019

Related U.S. Application Data
(60) Provisional application No. 62/753,260, filed on Oct. 31, 2018.

(51) Int. Cl. H04B 1/04; H04B 17/13

(52) U.S. Cl. CPC H04B 1/0475; H04B 2001/0425; H04B 17/13

(57) ABSTRACT

Disclosed herein are related to systems and methods for performing predistortion for communication. In one aspect, a coupler coupled to an output port of a power amplifier is disabled during a first time period, while a transmitter coupled to an input port of the power amplifier outputs a first transmit radio frequency (RF) signal. In one aspect, one or more first interference signals due to the first transmit RF signal are determined. In one aspect, the coupler is enabled during a second time period, while the transmitter outputs a second transmit RF signal. In one aspect, one or more second interference signals due to the second transmit RF signal are estimated, according to the determined one or more first interference signals. Based on the estimated one or more second interference signals, non-linearity of the power amplifier can be determined, and predistortion can be performed according to the determined non-linearity.

### CROSS-REFERENCE TO RELATED APPLICATION

This application claims priority to U.S. Provisional Patent Application No. 62/753,260, filed Oct. 31, 2018, which is incorporated by reference in its entirety for all purposes.

### FIELD OF THE DISCLOSURE

This disclosure generally relates to a communication system, including but not limited to performing predistortion for transmission despite of undesired interference through a lookback path.

### BACKGROUND OF THE DISCLOSURE

Recent developments in communication and computing devices demand higher bandwidth efficiency and reduced power consumption. To improve bandwidth efficiency, some complex modulation schemes may convey information through an amplitude, a phase, or a combination of the amplitude and the phase of a signal. For such modulation schemes, linearity of a power amplifier can be an important characteristic to ensure fidelity of communication. For example, a power amplifier is subject to non-linearity, because of inherent device characteristics, power restriction, etc. Such non-linearity of the power amplifier may prevent a successful decoding by a receiving device. In addition, such non-linearity of the power amplifier may cause undesired spectral emissions.

In one approach, a predistortion may be applied to compensate for the non-linearity of the power amplifier. For example, a signal output by the power amplifier can be measured to determine the non-linearity of the power amplifier, and a signal for transmission can be modified or adjusted to compensate for the determined non-linearity. However, unintended loopback interference from circuitry or transmission paths before the power amplifier may prevent accurate measurement or determination of the non-linearity of the power amplifier and may reduce efficacy of the predistortion.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1A is a block diagram depicting a network environment including one or more access points in communication with one or more devices or stations, in one or more embodiments.

FIGS. 1B and 1C are block diagrams depicting computing devices useful in connection with the methods and systems described herein, in one or more embodiments.

FIG. 2A is a block diagram depicting a communication system, in one or more embodiments.

FIG. 2B is a block diagram depicting the communication system of FIG. 2A operating during an interference modeling period, in one or more embodiments.

FIG. 2C is a block diagram depicting the communication system of FIG. 2A operating during a predistortion calibration period, in one or more embodiments.

FIG. 3A is a plot showing an improvement in AM-AM non-linearity of a power amplifier according to predistortion based on loopback interference modeling, in one or more embodiments.

FIG. 3B is a plot showing an improvement in AM-PM non-linearity of a power amplifier according to predistortion based on loopback interference modeling, in one or more embodiments.

FIG. 4 is a flow chart depicting a process of determining loopback interference and performing predistortion according to the loopback interference, in one or more embodiments.

The details of various embodiments of the methods and systems are set forth in the accompanying drawings and the description below.

### DETAILED DESCRIPTION

For purposes of reading the description of the various embodiments below, the following descriptions of the sections of the specification and their respective contents can be helpful:
Section A describes a network environment and computing environment which can be useful for practicing embodiments described herein; and
Section B describes embodiments of systems and methods for determining loopback interference, and performing predistortion calibration according to the determined loopback interference, according to one or more embodiments.

### A. Computing and Network Environment

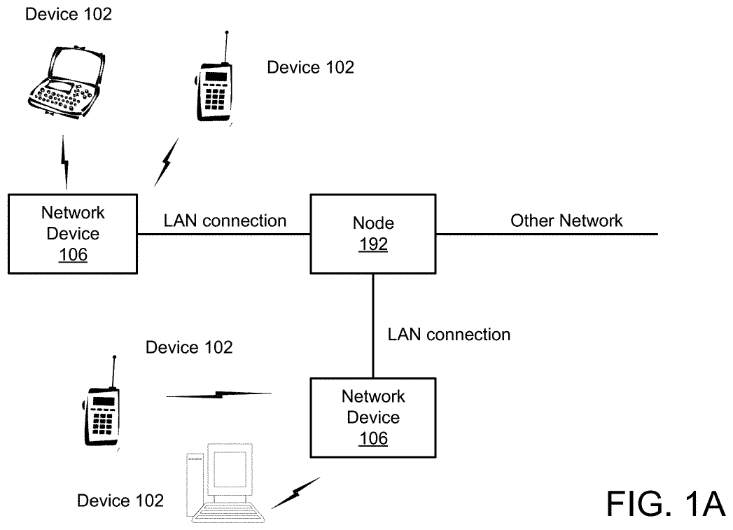

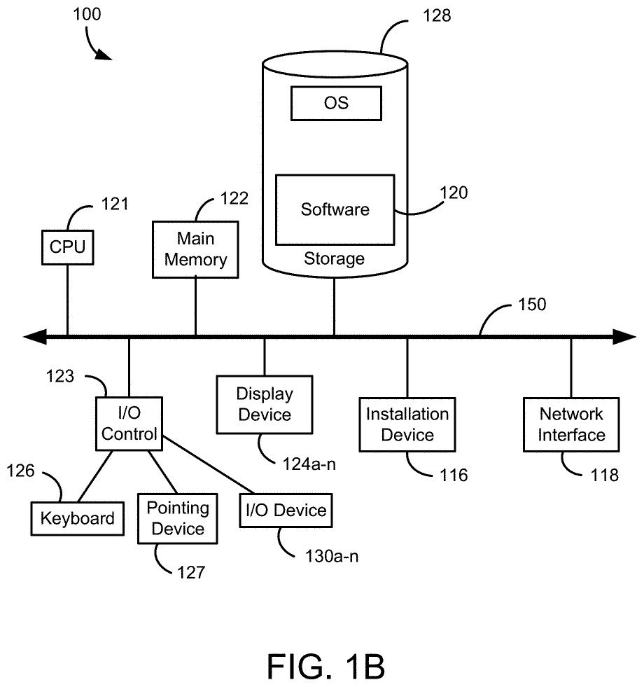

Prior to discussing specific embodiments of the present solution, it can be helpful to describe aspects of the operating environment as well as associated system components (e.g., hardware elements) in connection with the methods and systems described herein. Referring to FIG. 1A, an embodiment of a network environment is depicted. In brief overview, the network environment includes a wireless communication system that includes one or more access points (APs) 106, one or more wireless communication devices 102 and a network hardware component 192. The wireless communication devices 102 can for example include laptop computers 102, tablets 102, personal computers 102, Internet of Things (IoT) devices 102, and/or cellular telephone devices 102. The details of an embodiment of each wireless communication device 102 and/or AP 106 are described in greater detail with reference to FIGS. 1B and 1C. The network environment can be an ad hoc network environment, an infrastructure wireless network environment, a subnet environment, etc. in one embodiment. The APs 106 can be operably coupled to the network hardware component 192 via local area network connections. The network hardware component 192, which can include a router, gateway, switch, bridge, modem, system controller, appliance, etc., can provide a local area network connection for the communication system. Each of the APs 106 can have an associated antenna or an antenna array to communicate with the wireless communication devices in its area. The wireless communication devices 102 can register with a particular AP 106 to receive services from the communication system (e.g., via a SU-MIMO or MU-MIMO configuration). For direct connections (e.g., point-to-point communications), some wireless communication devices can communicate directly via an allocated channel and communications protocol. Some of the wireless communication devices 102 can be mobile or relatively static with respect to AP 106.

In some embodiments an AP 106 includes a device or module (including a combination of hardware and software) that allows wireless communication devices 102 to connect to a wired network using wireless-fidelity (WiFi), or other standards. An AP 106 can sometimes be referred to as an wireless access point (WAP). An AP 106 can be implemented (e.g., configured, designed and/or built) for operating in a wireless local area network (WLAN). An AP 106 can connect to a router (e.g., via a wired network) as a standalone device in some embodiments. In other embodiments, an AP 106 can be a component of a router. An AP 106 can provide multiple devices access to a network. An AP 106 can, for example, connect to a wired Ethernet connection and provide wireless connections using radio frequency links for other devices 102 to utilize that wired connection. An AP 106 can be implemented to support a standard for sending and receiving data using one or more radio frequencies. Those standards, and the frequencies they use can be defined by the IEEE (e.g., IEEE 802.11 standards). An AP 106 can be configured and/or used to support public Internet hotspots, and/or on a network to extend the network's Wi-Fi signal range.

In some embodiments, the APs 106 can be used for (e.g., in-home or in-building) wireless networks (e.g., IEEE 802.11, Bluetooth, ZigBee, any other type of radio frequency based network protocol and/or variations thereof). Each of the wireless communication devices 102 can include a built-in radio and/or is coupled to a radio. Such wireless communication devices 102 and/or APs 106 can operate in accordance with the various aspects of the disclosure as presented herein to enhance performance, reduce costs and/or size, and/or enhance broadband applications. Each wireless communication device 102 can have the capacity to function as a client node seeking access to resources (e.g., data, and connection to networked nodes such as servers) via one or more APs 106.

The network connections can include any type and/or form of network and can include any of the following: a point-to-point network, a broadcast network, a telecommunications network, a data communication network, a computer network. The topology of the network can be a bus, star, or ring network topology. The network can be of any such network topology as known to those ordinarily skilled in the art capable of supporting the operations described herein. In some embodiments, different types of data can be transmitted via different protocols. In other embodiments, the same types of data can be transmitted via different protocols.

The communications device(s) 102 and access point(s) 106 can be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the wireless communication devices 102 or AP 106. As shown in FIGS. 1B and 1C, each computing device 100 includes a central processing unit 121, and a main memory unit 122. As shown in FIG. 1B, a computing device 100 can include a storage device 128, an installation device 116, a network interface 118, an I/O controller 123, display devices 124a-124n, a keyboard 126 and a pointing device 127, such as a mouse. The storage device 128 can include an operating system and/or software. As shown in FIG. 1C, each computing device 100 can also include additional optional elements, such as a memory port 103, a bridge 170, one or more input/output devices 130a-130n, and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Santa Clara, Calif.; those manufactured by International Business Machines of White Plains, N.Y.; or those manufactured by Advanced Micro Devices of Sunnyvale, Calif. The computing device 100 can be based on any of these processors, or any other processor (e.g., integrated digital signal processor (DSP)) capable of operating as described herein.

Main memory unit 122 can be one or more memory chips capable of storing data and allowing any storage location to be directly accessed by the microprocessor or central processing unit 121, such as any type or variant of Static random access memory (SRAM), Dynamic random access memory (DRAM), Ferroelectric RAM (FRAM), NAND Flash, NOR Flash and Solid State Drives (SSD). The main memory unit 122 can be based on any of the above described memory chips, or any other available memory chips capable of operating as described herein. In the embodiment shown in FIG. 1B, the processor or central processing unit 121 communicates with main memory unit 122 via a system bus 150 (described in more detail below). FIG. 1C depicts an embodiment of a computing device 100 in which the processor communicates directly with main memory unit 122 via a memory port 103. For example, in FIG. 1C the main memory unit 122 can be DRDRAM.

FIG. 1C depicts an embodiment in which the main processor or central processing unit 121 communicates directly with cache memory 140 via a secondary bus, sometimes referred to as a backside bus. In other embodiments, the main processor or central processing unit 121 communicates with cache memory 140 using the system bus 150. Cache memory 140 typically has a faster response time than main memory unit 122 and is provided by, for example, SRAM, BSRAM, or EDRAM. In the embodiment shown in FIG. 1C, the processor or central processing unit 121 communicates with various I/O devices 130 via a local system bus 150. Various buses can be used to connect the central processing unit 121 to any of the I/O devices 130, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor or central processing unit 121 can use an Advanced Graphics Port (AGP) to communicate with the display 124. FIG. 1C depicts an embodiment of a computer device 100 in which the main processor or central processing unit 121 can communicate directly with I/O device 130b, for example via HYPERTRANSPORT, RAPIDIO, or INFINIBAND communications technology. FIG. 1C also depicts an embodiment in which local busses and direct communication are mixed: the processor or central processing unit 121 communicates with I/O device 130a using a local interconnect bus while communicating with I/O device 130b directly.

A wide variety of I/O devices 130a-130n can be present in the computing device 100. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices can be controlled by an I/O controller 123 as shown in FIG. 1B. The I/O controller can control one or more I/O devices such as a keyboard 126 and a pointing device 127, e.g., a mouse or optical pen. Furthermore, an I/O device can also provide storage and/or an installation medium or installation device 116 for the computing device 100. In still other embodiments, the computing device 100 can provide USB connections (not shown) to receive handheld USB storage devices such as the USB Flash Drive line of devices manufactured by Twintech Industry, Inc. of Los Alamitos, Calif.

Referring again to FIG. 1B, the computing device 100 can support any suitable installation device 116, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 100 can further include a storage device, such as one or more hard disk drives or redundant arrays of independent disks, for storing an operating system and other related software, and for storing application software programs such as any program or software 120 for implementing (e.g., configured and/or designed for) the systems and methods described herein. Optionally, any of the installation devices 116 could also be used as the storage device. Additionally, the operating system and the software can be run from a bootable medium.

Furthermore, the computing device 100 can include a network interface 118 to interface to the network 104 through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, IEEE 802.11ax, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 can include a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 can include or be connected to one or more display devices 124a-124n. As such, any of the I/O devices 130a-130n and/or the I/O controller 123 can include any type and/or form of suitable hardware, software, or combination of hardware and software to support, enable or provide for the connection and use of the display device(s) 124a-124n by the computing device 100. For example, the computing device 100 can include any type and/or form of video adapter, video card, driver, and/or library to interface, communicate, connect or otherwise use the display device(s) 124a-124n. In one embodiment, a video adapter can include multiple connectors to interface to the display device(s) 124a-124n. In other embodiments, the computing device 100 can include multiple video adapters, with each video adapter connected to the display device(s) 124a-124n. In some embodiments, any portion of the operating system of the computing device 100 can be configured for using multiple displays 124a-124n. In further embodiments, an I/O device 130 can be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing device 100 of the sort depicted in FIGS. 1B and 1C can operate under the control of an operating system, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, produced by Google Inc.; WINDOWS 7 and 8, produced by Microsoft Corporation of Redmond, Wash.; MAC OS, produced by Apple Computer of Cupertino, Calif.; WebOS, produced by Research In Motion (RIM); OS/2, produced by International Business Machines of Armonk, N.Y.; and Linux, a freely-available operating system distributed by Caldera Corp. of Salt Lake City, Utah, or any type and/or form of a Unix operating system, among others.

The computer device 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. In some embodiments, the computing device 100 can have different processors, operating systems, and input devices consistent with the device. For example, in one embodiment, the computing device 100 is a smart phone, mobile device, tablet or personal digital assistant. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Aspects of the operating environments and components described above will become apparent in the context of the systems and methods disclosed herein.

B. Predistortion Calibration based on Loopback Interference

Various embodiments disclosed herein are related to performing predistortion to compensate for non-linearity of a power amplifier despite of unintended interference. In one aspect, predistortion is performed through three time periods: an interference modeling period, a predistortion calibration period, and a transmission period.

In some embodiments, during the interference modeling period, interference from a pre-power amplifier transmitter before the power amplifier is modeled. In some embodiments, a pre-power amplifier transmitter is circuitry or a component coupled to an input port of the power amplifier that generates, conveys or propagates a signal at a transmission frequency (or a radio frequency (RF)) of the power amplifier. In one aspect, the pre-power amplifier transmitter includes an upconverter, a preamplifier, a transmission line coupled to the input port of the power amplifier, or any combination of them. The pre-power amplifier transmitter may be referred to as “a transmitter,” “a transmitter circuit” or “a transmitting path” herein. During the interference modeling period, the transmitter generates and outputs a first transmit RF signal, while a coupler disposed between an output port of the power amplifier and a loopback circuit is disabled or turned off. Hence, during the interference modeling period, an output port of the power amplifier is electrically decoupled from the loopback circuit. In one aspect, during the interference modeling period, one or more first interference signals radiated due to the first transmit RF signal output from the transmitter can be detected through the loopback circuit. Moreover, a model for estimating one or more interference signals due to a transmit RF signal output from the transmitter can be generated according to the detected one or more first interference signals due to the first transmit RF signal.

In some embodiments, during the predistortion calibration period, parameters for performing predistortion to compensate for non-linearity of the power amplifier are determined. In some embodiments, the transmitter generates a second transmit RF signal, and the power amplifier amplifies the second transmit RF signal to generate an amplified transmit RF signal, while the coupler is enabled or turned on during the predistortion calibration period. Hence, during the predistortion calibration period, one or more second interference signals radiated due to the second transmit RF signal output from the transmitter and the amplified transmit RF signal from the power amplifier can be detected through the loopback circuit. Meanwhile, during the predistortion calibration period, one or more second interference signals due to the second transmit RF signal are estimated according to the model obtained during the interference modeling period. In one approach, non-linearity of the power amplifier can be determined by subtracting the estimated one or more second interference signals from the signals detected through the loopback circuit during the interference modeling period. According to the determined non-linearity of the power amplifier, parameters (e.g., gain or delay amount) to perform predistortion can be determined to compensate for the non-linearity of the power amplifier.

In the transmission period, predistortion can be applied according to the determined parameters to generate a predistorted signal. In one approach, the predistorted signal is upconverted and transmitted through the transmitter and the power amplifier in the transmission period. Advantageously, by obtaining a first measurement through the loopback circuit while the coupler is disabled during the interference modeling period and by obtaining a second measurement through the loopback circuit while the coupler is enabled during the predistortion calibration period, non-linearity of the power amplifier can be determined despite of one or more interference signals from the transmitter. Moreover, parameters for performing predistortion can be determined according to the determined non-linearity of the power amplifier. Hence, predistortion can be performed despite of disturbance due to interference from the transmitter. Accordingly, fidelity of the communication can be enhanced.

Various embodiments disclosed herein are related to a communication system. In some embodiments, the system includes an interference estimator configured to generate a model for estimating one or more interference signals according to one or more first interference signals due to a first transmit radio (RF) signal output from a transmitter coupled to an input port of a power amplifier. In some embodiments, the interference estimator is configured to estimate, according to the model, one or more second interference signals due to a second transmit RF signal output from the transmitter. In some embodiments, the system includes a predistortion calibrator coupled to the interference estimator. In some embodiments, the predistortion calibrator is configured to determine, based on the estimated one or more second interference signals due to the second transmit RF signal, non-linearity of the power amplifier. In some embodiments, the system includes a predistortion generator coupled to the predistortion calibrator. In some embodiments, the predistortion generator is configured to perform predistortion to compensate for the non-linearity of the power amplifier.

In some embodiments, the transmitter is configured to transmit the first transmit RF signal during a first time period, and transmit the second transmit RF signal during a second time period. In some embodiments, the power amplifier is configured to amplify the second transmit RF signal to generate an amplified transmit RF signal during the second time period. In some embodiments, the system further includes a loopback circuit coupled to the interference estimator. In some embodiments, the loopback circuit is configured to receive a first receive RF signal indicating or corresponding to the one or more first interference signals due to the first transmit RF signal during the first time period, and receive a second receive RF signal indicating or corresponding to the one or more second interference signals due to the second transmit RF signal and the amplified transmit RF signal.

In some embodiments, the loopback circuit is further configured to downconvert the first receive RF signal to generate a first receive baseband signal, and downconvert the second receive RF signal to generate a second receive baseband signal. In some embodiments, the transmitter is configured to upconvert a first transmit baseband signal to generate the first transmit RF signal during the first time period, and upconvert a second transmit baseband signal to generate the second transmit RF signal during the second time period. In some embodiments, the interference estimator is configured to generate the model by comparing the first transmit baseband signal and the first receive baseband signal. In some embodiments, the interference estimator is configured to estimate the one or more second interference signals due to the second transmit RF signal by applying the second transmit baseband signal to the model.

In some embodiments, the system further includes an extractor coupled to the interference estimator, the loopback circuit, and the predistortion calibrator. In some embodiments, the extractor is configured to extract a signal of interest corresponding to the amplified transmit RF signal from the second receive baseband signal, according to the estimated one or more second interference signals due to the second transmit RF signal. In some embodiments, the predistortion calibrator is configured to determine, according to the signal of interest, parameters to perform the predistortion to compensate for the non-linearity of the power amplifier.

In some embodiments, the system further includes a coupler configured to electrically decouple an output port of the power amplifier from the loopback circuit during the first time period, and electrically couple the output port of the power amplifier to the loopback circuit during the second time period. In some embodiments, the coupler includes an RF switch coupled to the output port of the power amplifier. In some embodiments, the RF switch is opened during the first time period to electrically decouple the output port of the power amplifier from the loopback circuit during the first time period. In some embodiments, the RF switch is closed during the second time period to electrically couple the output port of the power amplifier to the loopback circuit during the second time period. In some embodiments, the coupler includes an attenuator to attenuate the amplified transmit RF signal.

Various embodiments disclosed herein are related to an integrated circuit for communication. In some embodiments, the integrated circuit includes a transmitter coupled to an input port of a power amplifier. In some embodiments, the transmitter is configured to transmit a first transmit radio frequency (RF) signal during a first time period, and transmit a second transmit RF signal during a second time period. In some embodiments, the integrated circuit includes an interference estimator configured to determine one or more first interference signals due to the first transmit RF signal, and estimate, according to the determined one or more first interference signals due to the first transmit RF signal, one or more second interference signals due to the second transmit RF signal. In some embodiments, the integrated circuit includes a predistortion calibrator coupled to the interference estimator. In some embodiments, the predistortion calibrator is configured to determine, based on the estimated one or more second interference signals due to the second transmit RF signal, non-linearity of the power amplifier. In some embodiments, the integrated circuit includes a predistortion generator coupled to the predistortion calibrator. In some embodiments, the predistortion generator is configured to perform predistortion to compensate for the non-linearity of the power amplifier.

In some embodiments, the power amplifier is configured to amplify the second transmit RF signal to generate an amplified transmit RF signal during the second time period. In some embodiments, the integrated circuit includes a loopback circuit coupled to the interference estimator. In some embodiments, the loopback circuit is configured to receive a first receive RF signal indicating or corresponding to the one or more first interference signals due to the first transmit RF signal during the first time period, and receive a second receive RF signal indicating or corresponding to the one or more second interference signals due to the second transmit RF signal and the amplified transmit RF signal. In some embodiments, the loopback circuit is further configured to downconvert the first receive RF signal to generate a first receive baseband signal, and downconvert the second receive RF signal to generate a second receive baseband signal. In some embodiments, the transmitter is configured to upconvert a first transmit baseband signal to generate the first transmit RF signal during the first time period, and upconvert a second transmit baseband signal to generate the second transmit RF signal during the second time period.

In some embodiments, the interference estimator is configured to determine a relationship between the first transmit baseband signal and the first receive baseband signal. In some embodiments, the interference estimator is configured to estimate the one or more second interference signals due to the second transmit RF signal according to the relationship between the first transmit baseband signal and the first receive baseband signal.

In some embodiments, the integrated circuit includes an extractor coupled to the interference estimator, the loopback circuit, and the predistortion calibrator. In some embodiments, the extractor is configured to extract a signal of interest corresponding to the amplified transmit RF signal from the second receive baseband signal, according to the estimated one or more second interference signals due to the second transmit RF signal. In some embodiments, the predistortion calibrator is configured to determine, according to the signal of interest, parameters to perform the predistortion to compensate for the non-linearity of the power amplifier.

In some embodiments, the integrated circuit includes a coupler configured to electrically decouple an output port of the power amplifier from the loopback circuit during the first time period, and electrically couple the output port of the power amplifier to the loopback circuit during the second time period.

Various embodiments disclosed herein are related to a method for communication. In some embodiments, the method includes disabling a coupler coupled to an output port of a power amplifier during a first time period, while a transmitter coupled to an input port of the power amplifier outputs a first transmit radio frequency (RF) signal. In some embodiments, the method includes determining one or more first interference signals due to the first transmit RF signal. In some embodiments, the method includes enabling the coupler during a second time period, while the transmitter outputs a second transmit RF signal. In some embodiments, the method includes estimating one or more second interference signals due to the second transmit RF signal according to the determined one or more first interference signals due to the first transmit RF signal. In some embodiments, the method includes determining, based on the estimated one or more second interference signals due to the second transmit RF signal, non-linearity of the power amplifier. In some embodiments, the method includes performing predistortion to compensate for the non-linearity of the power amplifier.

In some embodiments, estimating the one or more second interference signals due to the second transmit RF signal includes generating a model indicating a relationship between a first transmit baseband signal and the determined one or more first interference signals due to the first transmit RF signal. In some embodiments, the first transmit baseband signal is upconverted to generate the first transmit RF signal. In some embodiments, estimating the one or more second interference signals due to the second transmit RF signal includes applying a second transmit baseband signal for generating the second transmit RF signal to the model.

Various embodiments disclosed herein are related to a system for communication. In some embodiments, the system includes an antenna and transmission circuitry configured to provide data to the antenna for transmission. In some embodiments, the system includes correction circuitry configured to couple an output of the transmission circuitry to at least one input of the transmission circuitry. In some embodiments, the correction circuity is configured to estimate and extract one or more interference signals from the transmission circuitry into the correction circuitry, and correct non-linearity of the transmission circuitry based on the estimation and extraction of the one or more interference signals. In some embodiments, the transmission circuitry includes a power amplifier, and the correction circuitry is configured to correct non-linearity of the power amplifier. In some embodiments, the transmission circuitry includes one system on chip and a power amplifier.

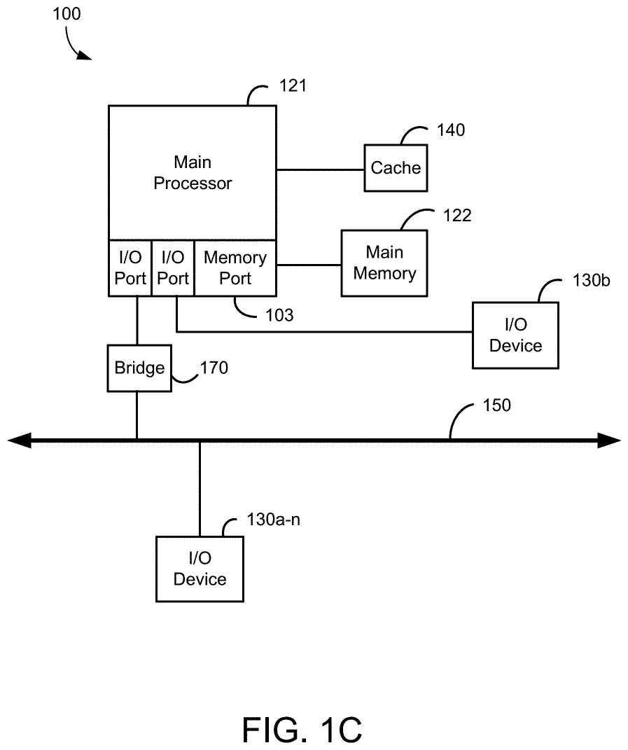

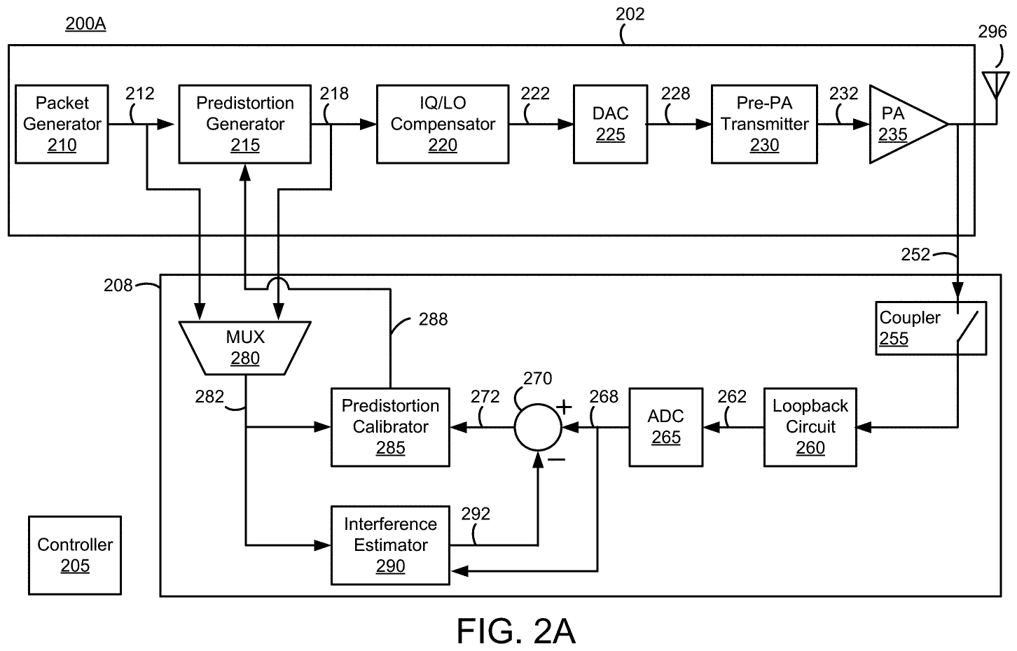

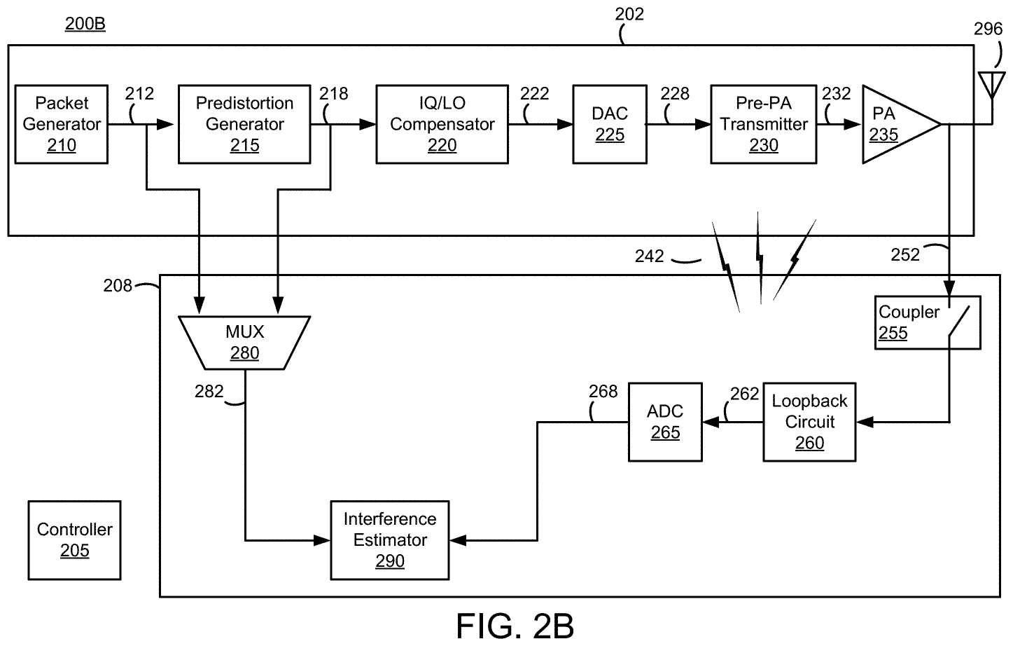

Referring to FIG. 2A, illustrated is a block diagram depicting a communication system 200A, in one or more embodiments. In some embodiments, the communication system 200A includes an antenna 296, transmission circuitry 202 (also referred to as “a transmission chain 202”), a controller 205, and correction circuitry 208. In some embodiments, the transmission circuitry 202 is configured to provide data to the antenna 296 for transmission. In some embodiments, the correction circuitry 208 is configured to couple an output of the transmission circuitry 202 to at least one input of the transmission circuitry 202. In some embodiments, the correction circuitry 208 is configured to estimate and extract one or more interference signals from the transmission circuitry 202 into the correction circuitry 208, and correct non-linearity of the transmission circuitry 202 based on the estimation and extraction of the one or more interference signals. In some embodiments, the transmission circuitry 202 includes a packet generator 210, a predistortion generator 215, an IQ/LO compensator 220, a digital to analog converter (DAC) 225, a pre-power amplifier transmitter 230 (also referred to as “a transmitter 230” or “a transmitter circuit 230”), and a power amplifier (PA) 235. In some embodiments, the correction circuitry 208 includes a coupler 255, a loopback circuit 260, an analog to digital converter (ADC) 265, a multiplexer (MUX) 280, an extractor 270, a predistortion calibrator 285, and an interference estimator 290. In some embodiments, these components are implemented as hardware, software, or a combination of them. In some implementations, these components are implemented on an application specific integrated circuit (ASIC), a field programmable gate logic (FPGA) or a combination of them. In one aspect, these components operate together to generate a modeling indicating one or more interferences due to a transmit RF signal output from the transmitter 230 before the power amplifier 235, and perform predistortion according to the model. In some embodiments, the communication system 200A includes more, fewer, or different components than shown in FIG. 2A. In some embodiments, the components 205, 210, 215, 220, 270, 280, 285, 290 are implemented as digital circuits, and the components 225, 230, 235, 255, 260, 265 are implemented as analog circuits. In other embodiments, some or all of the components 205, 210, 215, 220, 270, 280, 285, 290 are implemented as analog circuits, and the DAC 225 and the ADC 265 can be omitted or implemented at different locations.

In some embodiments, the packet generator 210 is a component that generates a packet 212 for transmission. In one implementation, the packet generator 210 is implemented as a digital logic circuit. In one configuration, the packet generator 210 includes an output port coupled to an input port of the predistortion generator 215 and an input port of the multiplexer 280. In one approach, the packet generator 210 generates one or more packets 212 including random data, or test data including a predetermined pattern, for example, during the interference modeling period and the predistortion calibration period. In one approach, the packet generator 210 generates one or more packets 212 including content data corresponding to a target baseband signal for transmission in a digital representation. In one configuration, the packet generator 210 provides the packet 212 to the predistortion generator 215 and the multiplexer 280, for example, in the digital representation.

In some embodiments, the predistortion generator 215 is a component that receives the packet 212 and performs predistortion to the packet 212 to generate a predistorted packet 218 corresponding to a predistorted baseband signal in the digital representation. In one implementation, the predistortion generator 215 is implemented as a digital logic circuit. In one configuration, the predistortion generator 215 includes a first input port, a second input port, and an output port. In one configuration, the first input port of the predistortion generator 215 is coupled to the output port of the packet generator 210 and the second input port of the predistortion generator 215 is coupled to an output port of the predistortion calibrator 285. In one configuration, the output port of the predistortion generator 215 is coupled to an input port of the IQ/LO compensator 220 and another input port of the multiplexer 280. In one approach, the predistortion generator 215 receives parameters for performing predistortion from the predistortion calibrator 285, and performs predistortion according to the received parameters. In some embodiments, parameters indicate or correspond to coefficients to alter different amplitudes, delay amounts or a combination of them for different amplitude ranges of data in the packet 212. For example, a first parameter indicates how to alter an amplitude or a delay for data in the packet 212 having an amplitude within a first range (e.g., 0˜0.3), a second parameter indicates how to alter an amplitude or a delay for data in the packet 212 having an amplitude within a second range (e.g., 0.3˜0.6), a third parameter indicates how to alter an amplitude or a delay for data in the packet 212 having an amplitude within a third range (e.g., 0.6˜0.8), and a fourth parameter indicates how to alter an amplitude or a delay for data in the packet 212 having an amplitude within a fourth range (e.g., 0.8˜1.0). In one implantation, the predistortion generator 215 provides the predistorted packet 218 corresponding to the predistorted baseband signal in the digital representation to the IQ/LO compensator 220.

In some embodiments, the IQ/LO compensator 220 is a component that performs compensation for IQ imbalance and local oscillator feedthrough. In one implementation, the IQ/LO compensator 220 is implemented as a digital logic circuit. In one configuration, the IQ/LO compensator 220 includes an input port coupled to the output port of the predistortion generator 215, and an output port coupled to an input port of the DAC 225. In this configuration, the IQ/LO compensator 220 performs compensation for the IQ imbalance and the local oscillator feedthrough by modifying the predistorted packet 218 to generate the modified packet 222. For example, the IQ/LO compensator 220 performs multiplication, addition, or filtering to the predistorted packet 218 to generate the modified packet 222. In one configuration, the IQ/LO compensator 220 provides the modified packet 222 to the DAC 225 in the digital representation. In some embodiments, the IQ/LO compensator 220 is omitted, and the predistortion generator 215 provides the predistorted packet 218 to the DAC 225.

In some embodiments, the DAC 225 is a component that converts the modified packet 222 or the predistorted packet 218 in the digital representation into an analog representation to generate a transmit baseband signal 228. In one implementation, the DAC 225 is implemented as an analog circuit or a mixed signal circuit. In one aspect, the transmit baseband signal 228 indicates, in the analog representation, the predistorted packet 218 from the predistortion generator 215 or the modified packet 222 from the IQ/LO compensator 220 for transmission through the transmitter 230. In one configuration, the DAC 225 includes an input port coupled to the output port of the IQ/LO compensator 220 and an output port coupled to an input port of the transmitter 230. In one configuration, the DAC 225 provides the transmit baseband signal 228 to the transmitter 230.

In some embodiments, the pre-power amplifier transmitter 230 is a component that receives the transmit baseband signal 228 and generates a transmit RF signal 232 for transmission. In one implementation, the transmitter 230 is implemented as an analog circuit or a mixed signal circuit. In one configuration, the transmitter 230 includes an input port coupled to the output port of the DAC 225 and an output port coupled to the input port of the power amplifier 235. In one configuration, the transmitter 230 includes an upconverter that upconverts the transmit baseband signal 228 by modulating the transmit baseband signal 228 with a local oscillator signal to generate the transmit RF signal 232. In one aspect, the upconverter upconverts the baseband signal at a baseband frequency (e.g., between DC and a few hundred MHz) to generate the transmit RF signal 232 at RF (e.g., over 1 GHz). In one configuration, the transmitter 230 includes a preamplifier coupled between the upconverter and the power amplifier 235. In one aspect, the preamplifier performs preamplification on the output of the upconverter.

In some embodiments, the power amplifier 235 is a component that amplifies the transmit RF signal 232 for transmission. In one implementation, the power amplifier 235 is implemented as an analog circuit. In one configuration, the power amplifier 235 includes an input port coupled to the output port of the transmitter 230 and an output port coupled to an antenna 296 and an input port of the coupler 255. In some embodiments, the components 205, 210, 215, 220, 225, 230, 255, 260, 265, 270, 280, 285, 290 are implemented on a single integrated circuit (e.g., a system on chip), where the power amplifier 235 is implemented on a separate integrated circuit. In some embodiments, the input port of the power amplifier 235 is coupled to the output port of the transmitter 230 through a transmission path. In one implementation, the transmission path includes a conductive material and is sized or has a dimension to allow the transmit RF signal 232 at the RF to be propagated to the power amplifier 235. The power amplifier 235 may amplify the transmit RF signal 232 and transmit the amplified transmit RF signal through an antenna 296 for communicating with another communication system.

In some embodiments, the coupler 255 is a component that electrically couples or decouples the output port of the power amplifier 235 to an input port of the loopback circuit 260, for example, according to a control signal or an instruction from the controller 205. In one implementation, the coupler 255 includes an input port coupled to the output port of the power amplifier 235 and an output port coupled to the input port of the loopback circuit 260. In some embodiments, the coupler 255 includes a switch (e.g., RF switch) that electrically couples or decouples the output port of the power amplifier 235 and the input port of the loopback circuit 260 according to the control signal from the controller 205. For example, the switch is turned off or disabled to decouple the output port of the power amplifier 235 from the input port of the loopback circuit 260 during the interference modeling period. For another example, the switch is turned on or enabled to couple the output port of the power amplifier 235 to the input port of the loopback circuit 260 during the predistortion calibration period. In some embodiments, the coupler 255 includes a filter and/or an attenuator coupled to the switch. The attenuator may attenuate a signal output at the output port of the power amplifier 235, for example, by between 20 and 40 dB to protect the loopback circuit from being damaged.

In some embodiments, the loopback circuit 260 is a component that detects or receives a receive RF signal at its input port, and generates a receive baseband signal 262. In one aspect, the receive RF signal received during the interference modeling period corresponds to one or more interference signals due to radiation of a transmit RF signal from the transmitter 230, for example, through undesired coupling or leakage. In one aspect, the receive RF signal received during the predistortion calibration period corresponds to one or more interference signals due to radiation from the transmitter 230, for example, through undesired coupling or leakage as well as an amplified transmit RF signal from the output port of the power amplifier through the coupler 255. In one implementation, the loopback circuit 260 is implemented as an analog circuit. In one configuration, the loopback circuit 260 includes a low noise amplifier (LNA) that amplifies the receive RF signal received through the coupler 255. In one configuration, the loopback circuit 260 includes a downconverter that downconverts a signal received at the output port of the LNA at the RF to generate the receive baseband signal 262 at the baseband frequency. In one implementation, the loopback circuit 260 shares one or more components (e.g., LNA, downconverter or a local oscillator) of a receiver (not shown). In one configuration, the loopback circuit 260 provides the receive baseband signal 262 to the ADC 265.

In some embodiments, the ADC 265 is a component that converts the receive baseband signal 262 in the analog representation into the digital representation to generate a receive baseband data 268. In one implementation, the ADC 265 is implemented as an analog circuit or a mixed signal circuit. In one aspect, the receive baseband data 268 indicates or represents, in the digital representation, the receive baseband signal 262 from the loopback circuit 260 for determining interference and non-linearity. In one configuration, the ADC 265 includes an input port coupled to the output port of the loopback circuit 260 and an output port coupled to an input port of the interference estimator 290 and an input port of the extractor 270. In one configuration, the ADC 265 provides the receive baseband data 268 to the interference estimator 290, the extractor 270, or both.

In some embodiments, the multiplexer 280 is a component that selects between the packet 212 and the predistorted packet 218, and provides a selected packet 282 to the predistortion calibrator 285 and the interference estimator 290. In one implementation, the multiplexer 280 is implemented as a digital logic circuit. In one configuration, the multiplexer 280 includes a first input port coupled to the output port of the packet generator 210, a second input port coupled to the output port of the predistortion generator 215, and an output port coupled to an input port of the predistortion calibrator 285 and an input port of the interference estimator 290. In one aspect, the multiplexer 280 selects either the packet 212 or the predistorted packet 218 according to a control signal from the controller 205. For example, the multiplexer 280 provides the packet 212 to the predistortion calibrator 285 to allow the predistortion calibrator 285 to measure performance of the predistortion. For example, the multiplexer 280 provides the predistorted packet 218 to the predistortion calibrator 285 and the interference estimator 290 to allow the predistortion calibrator 285 to perform predistortion calibration.

In some embodiments, the interference estimator 290 is a component that determines an interference of the transmit RF signal 232 from the transmitter 230. In one implementation, the interference estimator 290 is implemented as a digital logic circuit, a software executing on a processor, a firmware, an integrated digital signal processor, etc. In one configuration, the interference estimator 290 includes a first input port coupled to the output port of the multiplexer 280, a second input port coupled to the output port of the ADC 265, and an output port coupled to an input port of the extractor 270. In one approach, during the interference modeling period, the interference estimator 290 compares the predistorted packet 218 and the receive baseband data 268, and determines one or more interference signals due to the transmit RF signal 232, according to the comparison. For example, during the interference modeling period, the interference estimator 290 generates and stores a model (e.g., a linear model or a polynomial model) indicating a relationship between the predistorted packet 218 and the receive baseband data 268. In one example, the interference estimator 290 generates a model indicating a relationship between the predistorted packet 218 and the receive baseband data 268, according to the following equation:

\tilde{Z}=Z̅α, or \tilde{Z}(n)=Σ_{q=0}^{Q-1}Σₖ₌₁^{K}α_{kq}z(n−q)|z(n−q)|^{k-1}

where \tilde{Z} corresponds to receive baseband data, Z corresponds to transmit baseband data or the predistorted packet, a corresponds to modeling of one or more interference signals, n is a sample index of the transmitted signal in a baseband equivalent model, Q is a memory length of the leakage model, and K is a polynomial order. According to the model, during the predistortion calibration period, one or more interference signals due to another transmit RF signal can be predicted or estimated. For example, during the predistortion calibration period, the interference estimator 290 receives another predistorted packet 218, and applies the another predistorted packet 218 to the model to obtain or generate estimation data 292 indicating, at a baseband frequency, one or more estimated interference signals due to another transmit RF signal 232 that is generated based on the another predistorted packet 218. In one implementation, the interference estimator 290 provides the estimation data 292 to the extractor 270 during the predistortion calibration period.

In some embodiments, the extractor 270 is a component that generates, obtains, or extracts a signal of interest 272 from the receive baseband data 268. In one implementation, the extractor 270 is implemented as a digital logic circuit. In one configuration, the extractor 270 includes a first input port coupled to an output port of the ADC 265, a second input port coupled to an output port of the interference estimator 290, and an output port coupled to an input port of the predistortion calibrator 285. In one approach, during the predistortion calibration period, the extractor 270 subtracts the estimation data 292 from the receive baseband data 268, such that the signal of interest 272 corresponds to the amplified transmit RF signal 252 from the power amplifier 235 through the coupler 255 without the disturbance or influence by interference from the transmitter 230. In one implementation, during the predistortion calibration period, the extractor 270 provides the signal of interest 272 to the predistortion calibrator 285.

In some embodiments, the predistortion calibrator 285 is a component that determines non-linearity of the power amplifier 235 according to the signal of interest 272, and determines or adjusts the parameters 288 for performing predistortion. In one implementation, the predistortion calibrator 285 is implemented as a digital logic circuit. In one configuration, the predistortion calibrator 285 includes a first input port coupled to the output port of the multiplexer 280, a second input port coupled to the output port of the extractor 270, and an output port coupled to an input port of the predistortion generator 215. In one approach, the predistortion calibrator 285 compares the predistorted packet 218 and the signal of interest 272, and determines a range that is not linear, and the amount of non-linearity based on the comparison. For example, the predistortion calibrator 285 determines that the amplitude or the phase of the output of the power amplifier 235 is linear for an amplitude range corresponding to an amplitude of data between 0 and 0.6, the amplitude or the phase of the output of the power amplifier 235 is non-linear for a range corresponding to an amplitude of data between 0.6 and 0.8 by a first amount (e.g., 10%), and the amplitude or the phase of the output of the power amplifier 235 is non-linear for a range corresponding to an amplitude of data between 0.8 and 1.0 by a second amount (e.g., 20%). The predistortion calibrator 285 may determine and generate parameters 288 for performing predistortion to compensate for the determined non-linearity. For example above, the predistortion calibrator 285 may determine to multiply for data corresponding to amplitude between 0.6 and 0.8 by a coefficient of a coefficient of 1.1, and for data corresponding to amplitude between 0.8 and 1.0 by a coefficient of a coefficient of 1.2 to compensate for AM-AM non-linearity. For the example above, the predistortion calibrator 285 may determine to delay data corresponding to amplitude between 0.2 and 0.4 by a corresponding amount (e.g., 200 ns) to compensate for AM-PM non-linearity. In one implementation, the predistortion calibrator 285 provides the parameters 288 to the predistortion generator 215.

In some embodiments, the controller 205 is a component that configures various components of the system 200A for performing predistortion calibration according to interference. In one implementation, the controller 205 is implemented as a digital logic circuit, a state machine, software executing on a processor, a firmware, a digital signal processor, etc. In one implementation, the controller 205 is implemented as a processor that executes instructions to perform various processes for performing interference modeling and predistortion calibration disclosed herein. In some embodiments, during the interference modeling period, the controller 205 disables or turns off the coupler 255, while the transmitter 230 outputs a first transmit RF signal 232, and configures the interference estimator 290 to generate a model indicating one or more first interference signals due to the first transmit RF signal 232 at a baseband frequency. In some embodiments, during the predistortion calibration period, the controller 205 enables or turns on the coupler 255, while the transmitter 230 transmits or outputs a second transmit RF signal 232 and the power amplifier 235 amplifies the second transmit RF signal 232 to generate an amplified transmit RF signal 252. In some embodiments, the controller 205 configures the interference estimator 290 to estimate one or more second interference signals due to the second transmit RF signal 232 according to the determined model, and configures the predistortion calibrator 285 to perform predistortion calibration according to the estimated one or more second interference signals due to the second transmit RF signal 232. Detailed description on the interference modeling is provided below with respect to FIG. 2B. Detailed description on the predistortion calibration is provided below with respect to FIG. 2C.

Referring to FIG. 2B, illustrated is a block diagram depicting a communication system 200B operating during an interference modeling period, in one or more embodiments. In FIG. 2B, the extractor 270 and the predistortion calibrator 285 are not shown for simplicity. In one aspect, during the interference modeling period, the controller 205 configures the packet generator 210 to generate a packet (corresponding to a first transmit baseband signal in the digital representation). The controller 205 may configure the predistortion generator 215 to perform or bypass any predistortion during the interference modeling period. Similarly, the controller 205 may configure the IQ/LO compensator 220 to perform or bypass any compensation. In one aspect, the controller 205 configures the DAC 225 to convert the first transmit baseband signal in the digital representation into the analog representation. In some embodiments, during the interference modeling period, the controller 205 configures the transmitter 230 to upconvert the first transmit baseband signal to generate the first transmit RF signal 232, while the coupler 255 is disabled or turned off.

Although the coupler 255 is disabled or turned off during the interference modeling period, one or more interference signals due to the first transmit RF signal can be radiated from within the transmitter 230, from the output port of the transmitter 230, from the input port of the power amplifier 235, or a combination of them through undesired coupling or leakage 242. In one approach, during the interference modeling period, the controller 205 configures the loopback circuit 260 to detect one or more first interference signals due to the first transmit RF signal, to generate a first receive RF signal electrically representing the received or detected one or more first interference signals due to the first transmit RF signal, and to downconvert the first receive RF signal to generate a first receive baseband signal 262. The ADC 265 may convert the first receive baseband signal 262 in the analog representation into the digital representation. In some embodiments, during the interference modeling period, the controller 205 configures the interference estimator 290 to compare the first transmit baseband signal with the first receive baseband signal, and to generate a model indicating a relationship between the first transmit baseband signal and the first receive baseband signal. For example, during the interference modeling period, the interference estimator 290 analyzes generates a model indicating relationships indicating amplitudes and/or phases of the first receive baseband signal with respect to amplitudes of the first transmit baseband signal.

Referring to FIG. 2C, illustrated is a block diagram depicting a communication system 200C operating during a predistortion calibration period for performing predistortion calibration, in one or more embodiments. In one aspect, during the predistortion calibration period, the controller 205 configures the packet generator 210 to generate or provide a packet (corresponding to a second transmit baseband signal in the digital representation). The controller 205 may configure the predistortion generator 215 to bypass or omit any predistortion during the predistortion calibration period. Similarly, the controller 205 may configure the IQ/LO compensator 220 to bypass or omit any compensation. In one aspect, the controller 205 configures the DAC 225 to convert the second transmit baseband signal in the digital representation into the analog representation. In some embodiments, during the predistortion calibration period, the controller 205 configures the transmitter 230 to upconvert the second transmit baseband signal to generate the second transmit RF signal 232, and configures the power amplifier 235 to amplify the second transmit RF signal 232 to generate and output an amplified transmit RF signal. In some embodiments, during the predistortion calibration period, the power amplifier 235 is biased such that the power amplifier 235 operates in a linear mode (or class A mode).

In one approach, during the predistortion calibration period, the controller 205 configures the loopback circuit 260 to detect one or more second interference signals due to the second transmit RF signal through undesired coupling or leakage 242 as well as the amplified transmit RF signal from the output port of the power amplifier 235 through the coupler 255. The loopback circuit 260 may generate a second receive RF signal electrically representing the detected or received signal at the input port of the loopback circuit 260, and to downconvert the second receive RF signal into a second receive baseband signal. In one approach, the ADC 265 converts the second receive baseband signal 262 in the analog representation into the digital representation to generate a second receive baseband data 268.

In one approach, the controller 205 configures the interference estimator 290 to estimate one or more second interference signals due to the second transmit RF signal, during the predistortion calibration period. For example, during the predistortion calibration period, the interference estimator 290 obtains a model generated during the interference modeling period, and applies the second transmit baseband signal in the digital representation (e.g., packet 212 or 218) to the model to obtain estimation data 292 indicating, at a baseband frequency, one or more estimated second interference signals due to the second transmit RF signal 232.

In one approach, the controller 205 configures the extractor 270 to obtain a signal of interest corresponding to the amplified transmit RF signal from the output port of the power amplifier 235 through the coupler 255 during the predistortion calibration period. In one example, the extractor 270 subtracts the estimation data 292 from the second receive baseband data 268, such that the signal of interest 272 corresponds to the amplified transmit RF signal from the output port of the power amplifier 235 through the coupler 255 without the disturbance or influence by interference from the transmitter 230. During the predistortion calibration period, the predistortion calibrator 285 generates, determines, adjusts, or modifies parameters for performing predistortion, according to the signal of interest 272 and the second transmit baseband signal in the digital representation (e.g., packet 212 or 218). For example, during the predistortion calibration period, the predistortion calibrator 285 compares the signal of interest 272 and the second transmit baseband signal in the digital representation to determine non-linearity of the power amplifier 235, and determines parameters to correct or compensate for the determined non-linearity. In the transmission period, the predistortion generator 215 may perform predistortion on a target baseband data according to the determined parameters. Accordingly, non-linearity of the power amplifier 235 can be reduced or adjusted despite of unintended interference from the transmitter 230.

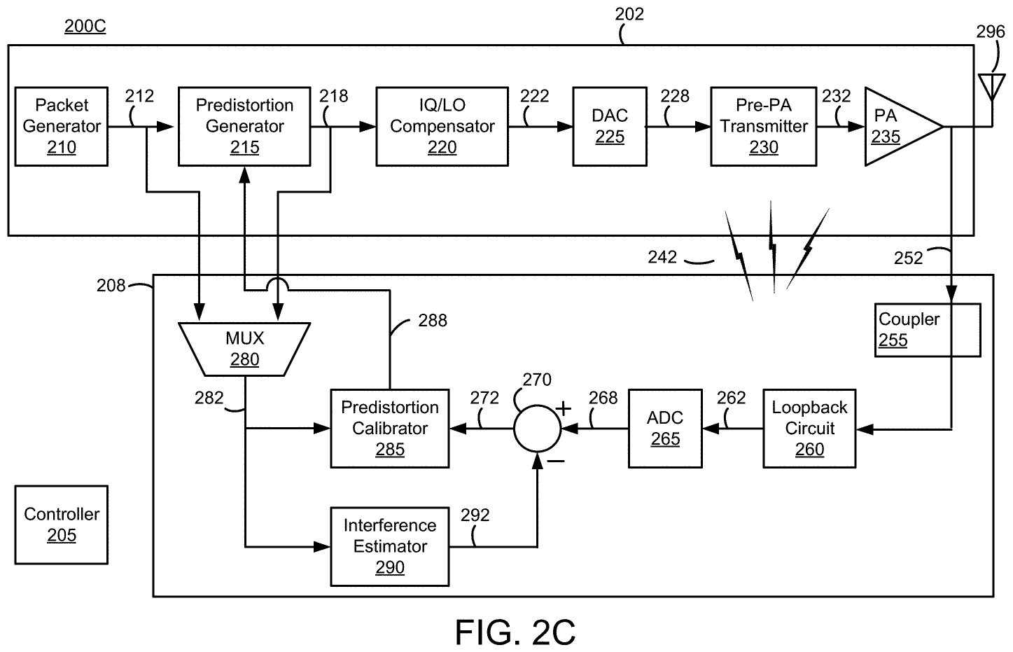

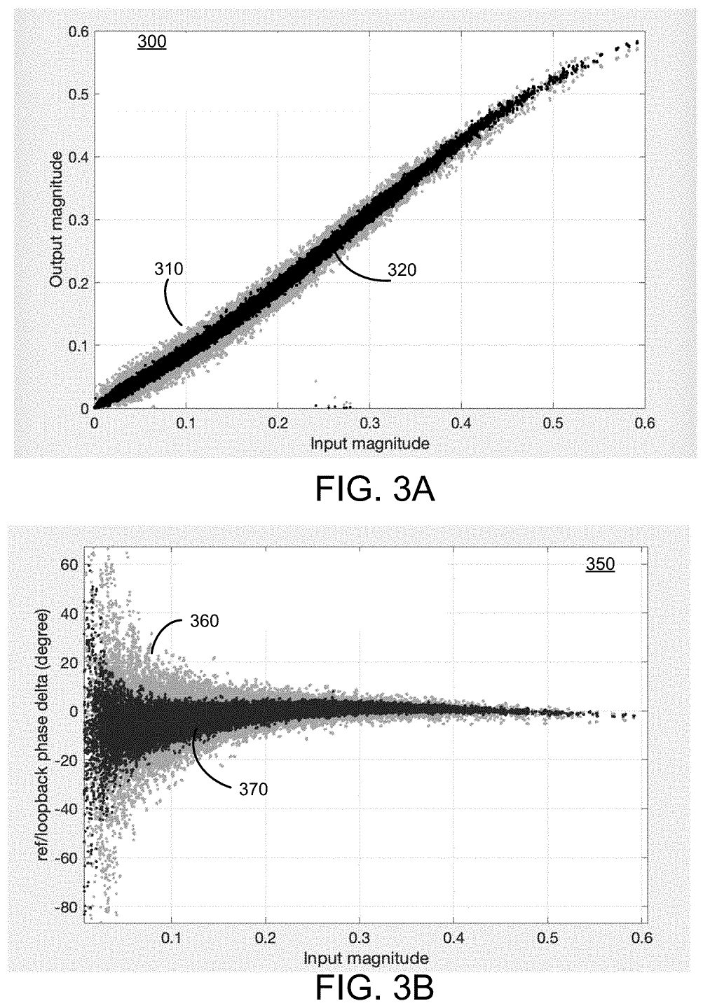

Referring to FIG. 3A is a plot 300 showing an improvement in AM-AM non-linearity of a power amplifier according to predistortion based on loopback interference modeling, in one or more embodiments. In FIG. 3A, X-Axis represents an amplitude (or magnitude) of the second transmit baseband signal, which corresponds to an input of the power amplifier 235, and Y-Axis represents an amplitude (or magnitude) of the signal of interest, which corresponds to an output of the power amplifier 235. In FIG. 3A, AM-AM non-linearity 320 after the disclosed predistortion calibration based on loopback interference can be reduced, compared to AM-AM non-linearity 310 without the disclosed predistortion calibration.

Referring to FIG. 3B is a plot 350 showing an improvement in AM-PM non-linearity of a power amplifier according to predistortion based on loopback interference modeling, in one or more embodiments. In FIG. 3B, X-Axis represents an amplitude (or magnitude) of the second transmit baseband signal, which corresponds to an input of the power amplifier 235, and Y-Axis represents a phase error of the signal of interest, which corresponds to an output of the power amplifier 235. In FIG. 3B, AM-PM non-linearity 370 after the disclosed predistortion calibration based on loopback interference can be reduced, compared to AM-PM non-linearity 360 without the disclosed predistortion calibration.

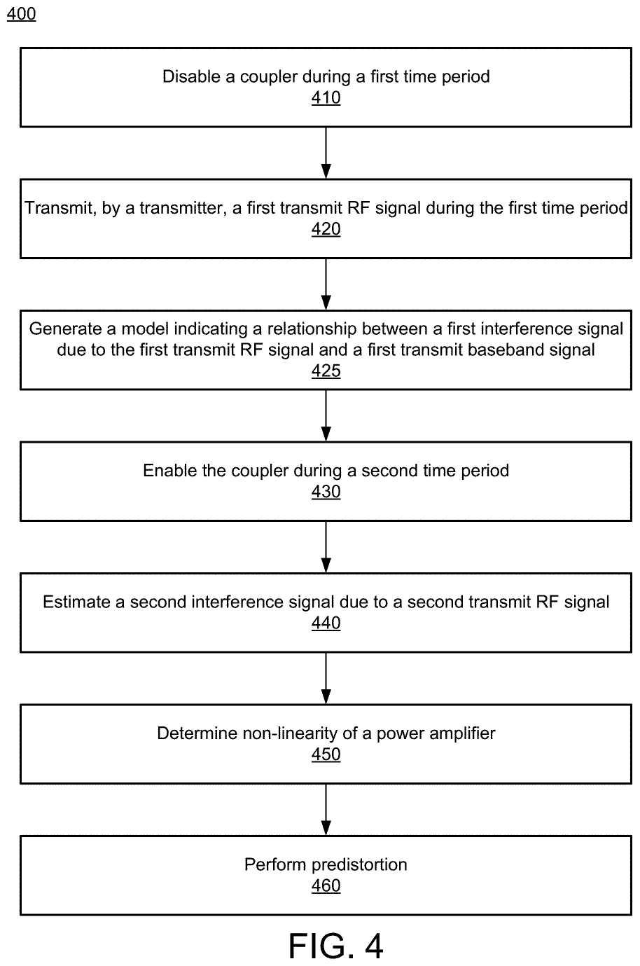

Referring to FIG. 4, illustrated is a flow chart depicting a process 400 of determining loopback interference and performing predistortion calibration according to the determined loopback interference, in one or more embodiments. In some embodiments, the process 400 is performed by the system 200 shown in FIGS. 2A-2C. In other embodiments, the process 400 is performed by other entities. In some embodiments, the process 400 includes more, fewer, or different steps than shown in FIG. 4.

In one approach, the controller 205 disables 410 the coupler 255 during the interference modeling period. In some embodiments, during the interference modeling period, the controller 205 configures the transmitter 230 to upconvert a first transmit baseband signal to generate the first transmit RF signal 232. While the coupler 255 is disabled during the interference modeling period, in one approach, the transmitter 230 transmits 420 the first transmit RF signal. During the interference modeling period, the power amplifier 235 may amplify the first transmit RF signal to generate and output an amplified first transmit RF signal.

During the interference modeling period, the controller 205 configures the interference estimator 290 to generate 425 a model indicating a relationship between the first transmit baseband signal and one or more interference signals due to the first transmit RF signal represented at the baseband frequency. Although the coupler 255 is disabled during the interference modeling period, one or more interference signals due to the first transmit RF signal 232 can be radiated from the output of the transmitter 230 through undesired coupling or leakage. The amplified first transmit RF signal may not be detected by the loopback circuit 260 or may be suppressed during the interference modeling period, because the coupler 255 is disabled. In one approach, during the interference modeling period, the controller 205 configures the loopback circuit 260 to receive the one or more interference signals due to the first transmit RF signal 232, to generate a first receive RF signal electrically representing the received or detected one or more interference signals due to the first transmit RF signal 232, and to downconvert the first receive RF signal into a first receive baseband signal. In some embodiments, during the interference modeling period, the controller 205 configures the interference estimator 290 to compare the first transmit baseband signal with the first receive baseband signal, and to generate a model indicating a relationship between the first transmit baseband signal and the first receive baseband signal.

In one approach, the controller 205 enables 430 the coupler 255 during the predistortion calibration period. In some embodiments, during the predistortion calibration period, the controller 205 configures the transmitter 230 to upconvert a second transmit baseband signal to generate the second transmit RF signal 232. During the predistortion calibration period, the power amplifier 235 amplifies the second transmit baseband signal to generate an amplified second transmit RF signal. In one approach, during the predistortion calibration period, the controller 205 configures the loopback circuit 260 to receive or detect one or more second interference signals due to the second transmit RF signal 232 through undesired coupling or leakage as well as the second transmit RF signal 232 from the power amplifier 235 through the coupler 255. During the predistortion calibration period, the controller 205 configures the loopback circuit 260 to generate a second receive RF signal electrically representing the received or detected signal, and to downconvert the second receive RF signal into a second receive baseband signal.

In one approach, during the predistortion calibration period, the controller 205 configures the interference estimator 290 to estimate 440 or predict one or more interference signals due to the second transmit RF signal, according to the one or more first interference signals due to the first transmit RF signal. For example, during the predistortion calibration period, the interference estimator 290 retrieves a model generated during the interference modeling period according to the one or more first interference signals due to the first transmit RF signal, and applies the second transmit baseband signal to the model to obtain estimation data 292 indicating, at a baseband frequency, one or more estimated interference signals due to the second transmit RF signal 232.

In one approach, the controller 205 configures the predistortion calibrator 285 to determine parameters for performing predistortion according to the estimated one or more second interference signals due to the second transmit RF signal. In one approach, the controller 205 configures the extractor 270 to obtain a signal of interest corresponding to non-linearity of the power amplifier 235 during the predistortion calibration period. In one example, the extractor 270 subtracts the estimation data 292 from the second receive baseband data 268, such that the signal of interest 272 corresponds to the amplified transmit RF signal from the power amplifier 235 without or less disturbance or influence due to undesired coupling or leakage from the transmitter 230. During the predistortion calibration period, the predistortion calibrator 285 generates, determines, adjusts, or modifies parameters for performing predistortion, according to the signal of interest 272 and the second transmit baseband signal. For example, during the predistortion calibration period, the predistortion calibrator 285 compares the signal of interest 272 and the second transmit baseband signal in the digital representation to determine non-linearity of the power amplifier 235, and determines parameters to correct or compensate for the determined non-linearity. In the transmission period, the predistortion generator 215 may perform predistortion on a target baseband data according to the determined parameters. Accordingly, non-linearity of the power amplifier 235 can be reduced or adjusted despite of unintended interference from the transmitter 230.

It should be noted that certain passages of this disclosure can reference terms such as “first” and “second” in connection with subsets of transmit spatial streams, sounding frames, response, and devices, for purposes of identifying or differentiating one from another or from others. These terms are not intended to merely relate entities (e.g., a first device and a second device) temporally or according to a sequence, although in some cases, these entities can include such a relationship. Nor do these terms limit the number of possible entities that can operate within a system or environment. It should be understood that the systems described above can provide multiple ones of any or each of those components and these components can be provided on either a standalone machine or, in some embodiments, on multiple machines in a distributed system. In addition, the systems and methods described above can be provided as one or more computer-readable programs or executable instructions embodied on or in one or more articles of manufacture, e.g., a floppy disk, a hard disk, a CD-ROM, a flash memory card, a PROM, a RAM, a ROM, or a magnetic tape. The programs can be implemented in any programming language, such as LISP, PERL, C, C++, C#, or in any byte code language such as JAVA. The software programs or executable instructions can be stored on or in one or more articles of manufacture as object code.

While the foregoing written description of the methods and systems enables one of ordinary skill to make and use embodiments thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

We claim:

1. A system including:
an interference estimator configured to:
generate a model for estimating one or more interference signals according to one or more first interference signals due to a first transmit radio (RF) signal output from a transmitter coupled to an input port of a power amplifier, and
estimate, according to the model, one or more second interference signals due to a second transmit RF signal output from the transmitter;
a predistortion calibrator coupled to the interference estimator, the predistortion calibrator configured to determine, based on the estimated one or more second interference signals due to the second transmit RF signal, non-linearity of the power amplifier; and
a predistortion generator coupled to the predistortion calibrator, the predistortion generator configured to perform predistortion to compensate for the non-linearity of the power amplifier.

2. The system of claim 1, wherein the transmitter is configured to:
transmit the first transmit RF signal during a first time period, and
transmit the second transmit RF signal during a second time period.

3. The system of claim 2, wherein the power amplifier is configured to amplify the second transmit RF signal to generate an amplified transmit RF signal during the second time period, the system further comprising:
a loopback circuit coupled to the interference estimator, the loopback circuit configured to:
receive a first receive RF signal indicating the one or more first interference signals due to the first transmit RF signal during the first time period, and
receive a second receive RF signal indicating the one or more second interference signals due to the second transmit RF signal and the amplified transmit RF signal.

4. The system of claim 3, wherein the loopback circuit is further configured to:
downconvert the first receive RF signal to generate a first receive baseband signal, and
downconvert the second receive RF signal to generate a second receive baseband signal.

5. The system of claim 4, wherein the transmitter is configured to:
upconvert a first transmit baseband signal to generate the first transmit RF signal during the first time period, and
upconvert a second transmit baseband signal to generate the second transmit RF signal during the second time period.

6. The system of claim 5, wherein the interference estimator is configured to generate the model by comparing the first transmit baseband signal and the first receive baseband signal.

7. The system of claim 5, wherein the interference estimator is configured to estimate the one or more second interference signals due to the second transmit RF signal by applying the second transmit baseband signal to the model.

8. The system of claim 4, further comprising:
an extractor coupled to the interference estimator, the loopback circuit, and the predistortion calibrator, the extractor configured to extract a signal of interest corresponding to the amplified transmit RF signal from the second receive baseband signal, according to the estimated one or more second interference signals due to the second transmit RF signal,
wherein the predistortion calibrator is configured to determine, according to the signal of interest, parameters to perform the predistortion to compensate for the non-linearity of the power amplifier.

9. The system of claim 3, further comprising:
a coupler configured to:
electrically decouple an output port of the power amplifier from the loopback circuit during the first time period, and
electrically couple the output port of the power amplifier to the loopback circuit during the second time period.

10. The system of claim 9, wherein the coupler includes:
an RF switch coupled to the output port of the power amplifier, the RF switch opened during the first time period to electrically decouple the output port of the power amplifier from the loopback circuit during the first time period, the RF switch closed during the second time period to electrically couple the output port of the power amplifier to the loopback circuit during the second time period.

11. The system of claim 10, wherein the coupler includes:
an attenuator to attenuate the amplified transmit RF signal.

12. An integrated circuit comprising:
a transmitter coupled to an input port of a power amplifier, the transmitter configured to:
transmit a first transmit radio frequency (RF) signal during a first time period, and transmit a second transmit RF signal during a second time period;
an interference estimator configured to:
determine one or more first interference signals due to the first transmit RF signal, and
estimate, according to the determined one or more first interference signals due to the first transmit RF signal, one or more second interference signals due to the second transmit RF signal;
a predistortion calibrator coupled to the interference estimator, the predistortion calibrator configured to determine, based on the estimated one or more second interference signals due to the second transmit RF signal, non-linearity of the power amplifier; and
a predistortion generator coupled to the predistortion calibrator, the predistortion generator configured to perform predistortion to compensate for the non-linearity of the power amplifier.

13. The integrated circuit of claim 12, wherein the power amplifier is configured to amplify the second transmit RF signal to generate an amplified transmit RF signal during the second time period, the integrated circuit further comprising:
a loopback circuit coupled to the interference estimator, the loopback circuit configured to:
receive a first receive RF signal indicating the one or more first interference signals due to the first transmit RF signal during the first time period, and
receive a second receive RF signal indiacting the one or more second interference signals due to the second transmit RF signal and the amplified transmit RF signal.

14. The integrated circuit of claim 13, wherein the loopback circuit is further configured to:
downconvert the first receive RF signal to generate a first receive baseband signal, and
downconvert the second receive RF signal to generate a second receive baseband signal.

15. The integrated circuit of claim 14, wherein the transmitter is configured to:
upconvert a first transmit baseband signal to generate the first transmit RF signal during the first time period, and
upconvert a second transmit baseband signal to generate the second transmit RF signal during the second time period.

16. The integrated circuit of claim 15, wherein the interference estimator is configured to determine a relationship between the first transmit baseband signal and the first receive baseband signal, wherein the interference estimator is configured to estimate the one or more second interference signals due to the second transmit RF signal according to the relationship between the first transmit baseband signal and the first receive baseband signal.

17. The integrated circuit of claim 14, further comprising:
an extractor coupled to the interference estimator, the loopback circuit, and the predistortion calibrator, the extractor configured to extract a signal of interest corresponding to the amplified transmit RF signal from the second receive baseband signal, according to the estimated one or more second interference signals due to the second transmit RF signal,
wherein the predistortion calibrator is configured to determine, according to the signal of interest, parameters to perform the predistortion to compensate for the non-linearity of the power amplifier.

18. A system comprising:
an antenna;
transmission circuitry configured to provide data to the antenna for transmission; and
correction circuitry configured to couple an output of the transmission circuitry to at least one input of the transmission circuitry, wherein the correction circuity is configured to:
estimate and extract one or more interference signals from the transmission circuitry into the correction circuitry, and
correct non-linearity of the transmission circuitry based on the estimation and extraction of the one or more interference signals.

19. The system of claim 18, wherein the transmission circuitry includes a power amplifier, wherein the correction circuitry is configured to correct non-linearity of the power amplifier.

20. The system of claim 18, wherein the transmission circuitry includes one system on chip and a power amplifier.
